(19) United States
(12) Patent Application Publication
(10) Pub. No.: US 2007/0207832 A1
(43) Pub. Date: Sep. 6, 2007

(54) Method for obtaining multiple video streams from an event

(76) Inventors: Michael M. Gerardi, Menifee, CA (US); Gregory A. Piccionelli, Westlake Village, CA (US)

Correspondence Address: Michael M. Gerardi, 28876 Woodcrest Lake Drive, Menifee, CA, 92584, US

(21) Appl. No.: 11/368,281

(22) Filed: Mar. 3, 2006

(51) Int. Cl. H04H 7/00; H04M 1/00

(52) U.S. Cl. 455/556.1; 455/3.06

(57) ABSTRACT

A method of obtaining video information pertaining to an event includes the steps of obtaining the location of an event, transmitting the location of the event to members of an organization, receiving a video transmission of the event from a cellular telephone operated by at least one member of the organization, and posting at least a portion of the video transmission on a site on a network

### FIELD OF THE INVENTION

The present invention relates to a method of obtaining multiple video streams from an event, in particular a newsworthy event such as a political rally, natural disaster, traffic accident and the like. More particularly, the present invention relates to a method of obtaining such video streams from cellular telephones equipped with video cameras.

### BACKGROUND OF THE INVENTION

Modern telecommunications technology has facilitated the rapid coverage of newsworthy events and the dissemination of real-time news reports to television, cable and radio outlets worldwide. The public appetite for news appears to be insatiable, and has given rise to 24-hour networks such as Fox News, CNN, MSNBC and the like.

Although modern news networks support large teams of reporters, it is virtually impossible for network reporters to cover all newsworthy events. Furthermore, those events which are covered by network reporters typically are only covered from one camera angle, using a single camera. Single-camera coverage can result in loss of coverage of all aspects of the event.

A need exists for a method of obtaining video transmissions of events, in particular newsworthy events, as soon as possible, preferably live. A need also exists for a method of obtaining video transmissions of events from multiple camera angles.

### SUMMARY OF THE PREFERRED EMBODIMENTS

In accordance with one aspect of the present invention, there is provided a method of obtaining video information pertaining to an event. The method includes the steps of: obtaining the location of an event; transmitting the location of the event to members of an organization; receiving a video transmission of the event from a cellular telephone operated by at least one member of the organization; and posting at least a portion of the video transmission on a site on a network.

According to particular embodiments, the event is located by its GPS coordinates, and the GPS coordinates of the site at which the event occurs are transmitted to a central site maintained by the organization. These coordinates can be provided by a member of the organization via a cellular telephone, in more specific embodiments via a cellular telephone equipped with a GPS device, or by other individuals or organizations.

In more specific embodiments, one or more video transmissions are provided to a central site maintained by the organization. Portions of one or more of the video transmissions can then be posted on the site. Very specific embodiments further provide for the attribution of copyright to the member or members providing the video transmissions to the central site, and also for the provision of a premium, such as monetary compensation, to members providing video transmissions to the central site.

In accordance with another aspect of the present invention, there is provided a method of providing video information pertaining to an event to a site on a network maintained by an organization. The method includes the step of transmitting information identifying the location of an event to a central site maintained by an organization, whereby upon receipt of the information the central site transmits the information to members of an organization and prompts at least a portion of the members to attend the event and provide to the central site video transmissions of the event from cellular telephones operated by such members. The central site subsequently posts at least a portion of the video transmissions on a site on a network maintained by the organization.

The GPS coordinates of the site at which the event occurs are transmitted to the central site maintained by the organization in more specific embodiments.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a depiction of an event being witnessed by a member of an organization who provides the location of the event to the organization, and more particularly also provides a video transmission of the event, using a cellular telephone equipped with a video camera,

FIG. 2 depicts provision of the event location and video transmission of FIG. 1 to the organization via the cellular telephone,

FIG. 3 depicts transmission of a notice of the event to other members of the organization,

FIG. 4 depicts a plurality of members providing video transmissions of the event after receiving notice of the event, the members providing the transmissions from different camera angles,

FIG. 5 is a representation of a web page on a site maintained by the organization, including a selection of views of the event as provided by members of the organization, and

FIG. 6 is a representation of a window including at least a portion of a selected video transmission, including attribution of copyright to the member providing the video transmission.

### DETAILED DESCRIPTION OF THE PREFERRED EMBODIMENTS

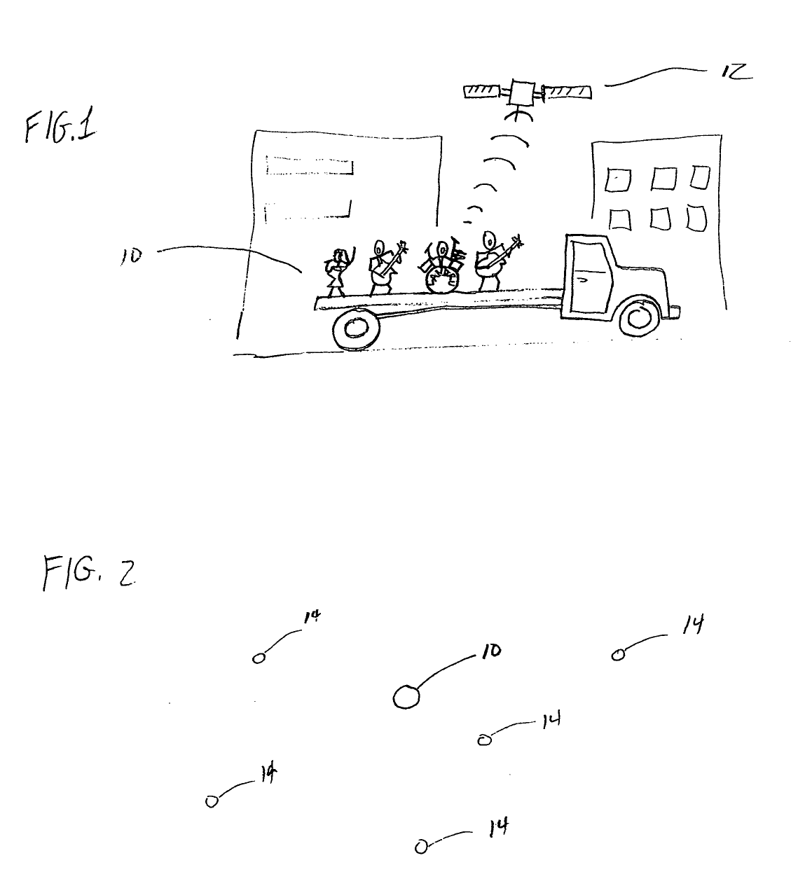

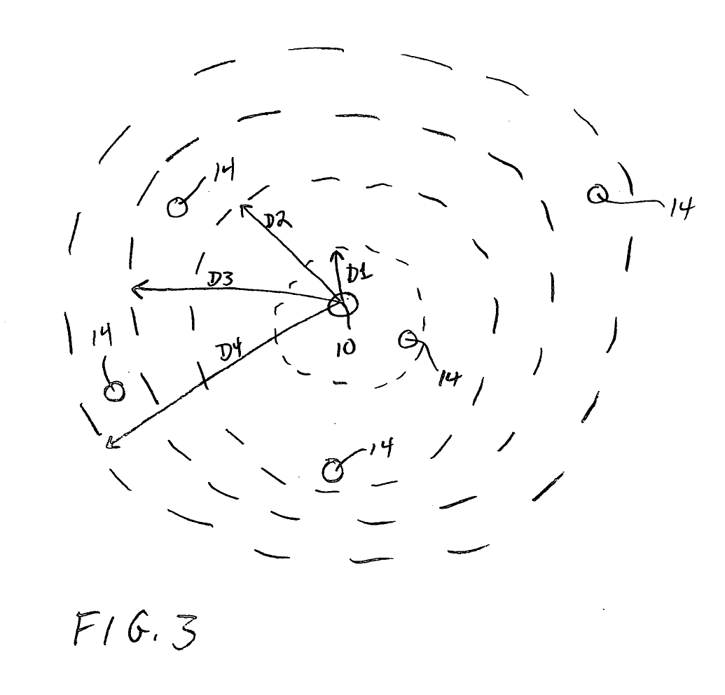

FIGS. 1-5 illustrates a method according to the present invention in which members of an organization are prompted to assemble at a site at which an event is occurring and provide video coverage of the event, in a manner reminiscent of the Star Trek episode “The Return of the Archons,” in which the computer “Landru” summons “The Body”. In FIG. 1, one or more individuals witness an event, more particularly a newsworthy event such as a political meeting, a natural disaster, a traffic accident, a car chase, a terrorist incident, etc. The witnesses can include, in particular embodiments, one or more members of an organization. The location of the event is provided to the organization, either by a member of the organization or by one or more non-members (FIG. 2).

The location can be provided by any desired means, such as a cellular telephone 10, more particularly a cellular telephone equipped with a video camera 12, and even more particularly by a cellular telephone also equipped with a GPS location device. Other means for providing the location of the event to the organization, such as via a network such as the Internet, via conventional telephone, or the like, can also be employed.

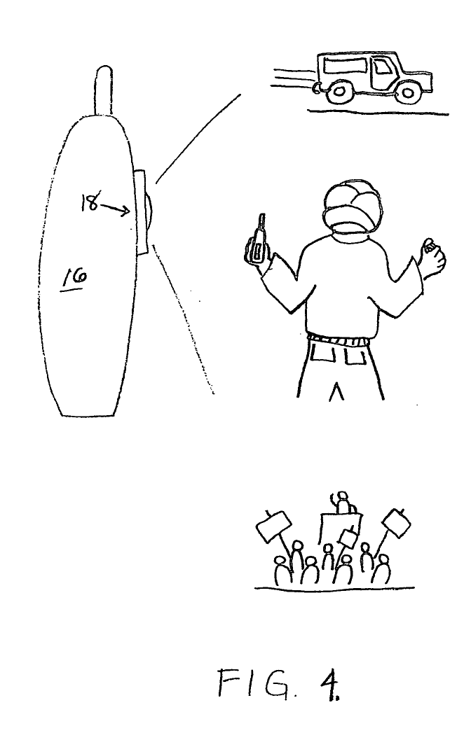

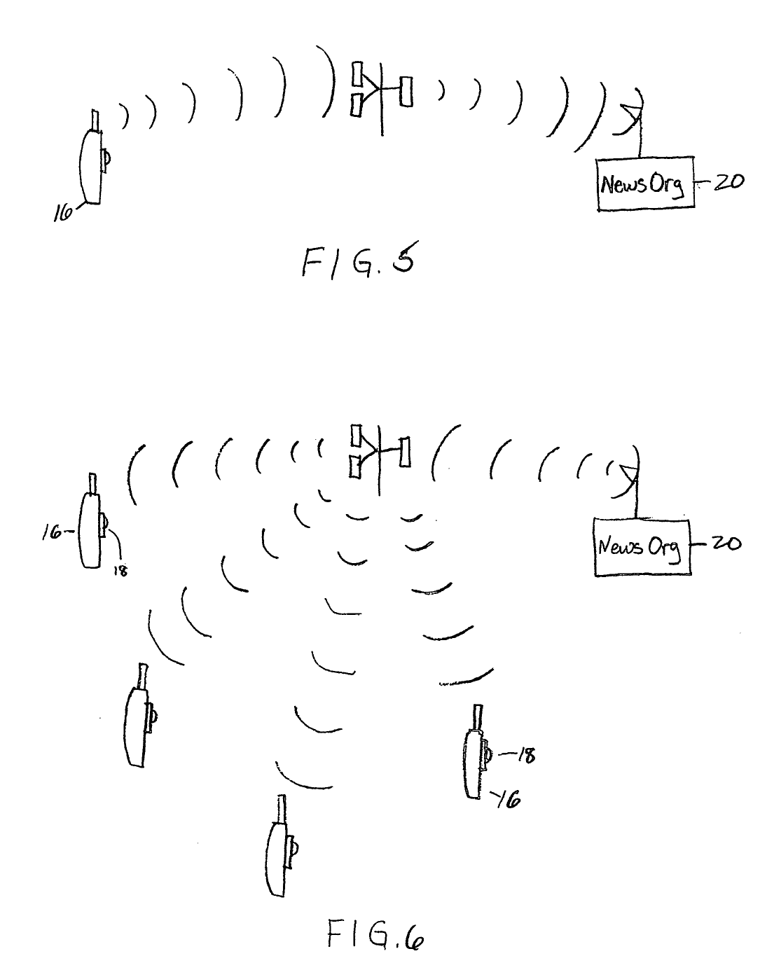

Once the organization receives the location of the event, the organization notifies members of the organization (FIG. 3). The notification can include, in particular embodiments, a description of the event, a video transmission of the event, links to sites pertaining to the event, as well as the location of the event. Members of the organization are prompted by the notification to proceed to the location of the event. Once at the site of the event, members of the organization activate cellular telephones 10 including video cameras 12 and provide video transmissions of the event to the organization. In more specific embodiments, a plurality of members provide video transmissions of the event from multiple camera angles (FIG. 4).

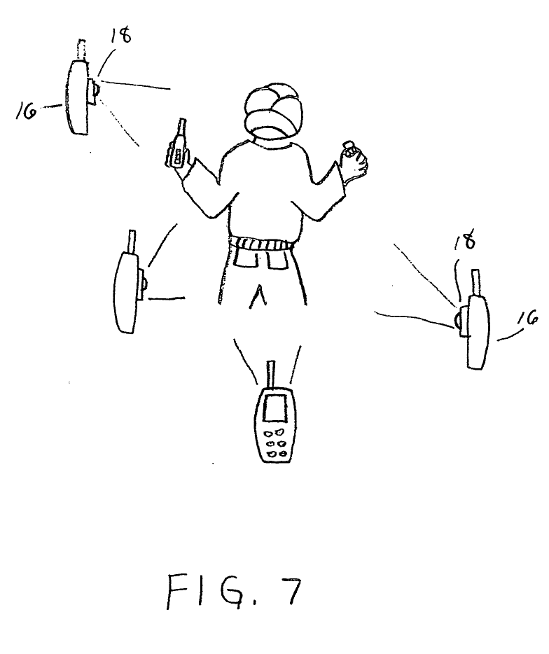

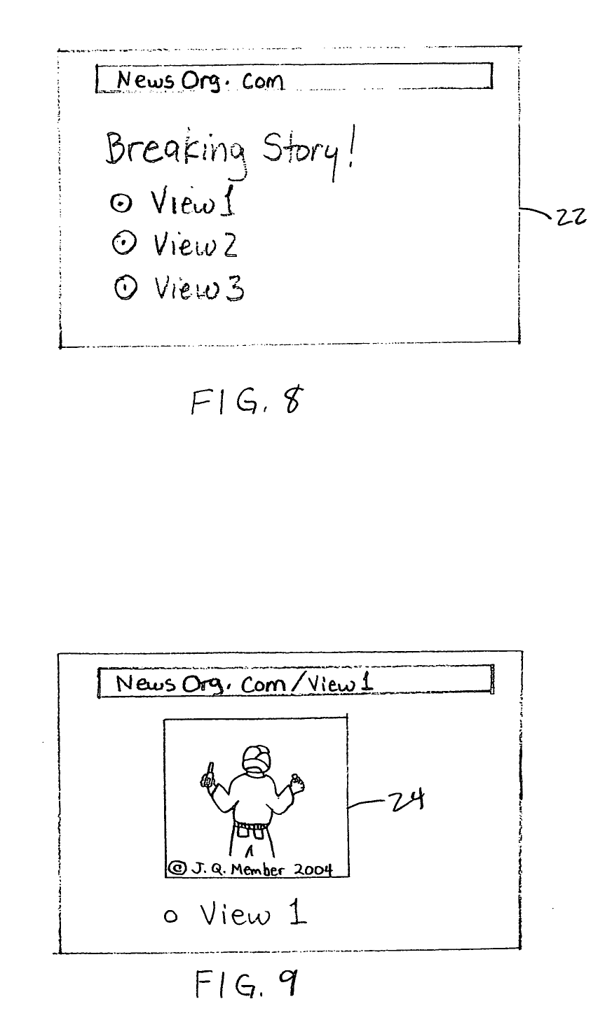

Once the organization receives one or more video transmissions from members present at the event, the organization makes at least a portion of the video transmissions available on a web page 14 on a site maintained by the organization on a network, for example the Internet (FIG. 5). A site viewer is provided with a menu, in particular embodiments, which includes a selection of one or more views of the event provided by organization members. The site viewer then opens a window 16 for the desired view (FIG. 6).

Some images obtained by organization members may prove to be particularly memorable or have significant commercial value, and the members thus may desire to secure copyrights in such images. Thus, the organization, in specific embodiments, includes a copyright notice with video transmissions provided by organization members (see FIG. 6). The organization optionally provides the member whose video transmission is posted with a copyright application to be filled out and submitted to the U.S. Copyright Office, or alternatively with a link to the U.S. Copyright Office web site so that the member can obtain a copyright application. The organization optionally further provides a premium, such as a monetary reward, a membership extension, a tangible good such as a plaque or certificate, or the like, to members whose video transmissions are posted on the organization's site. This premium can be provided in exchange for the copyrights to the video transmissions and images contained therein.

What is claimed is:

1. A method of obtaining video information pertaining to an event, the method comprising the steps of:
i) obtaining the location of an event,
ii) transmitting the location of the event to members of an organization,
iii) receiving a video transmission of the event from a cellular telephone operated by at least one member of the organization, and
iv) posting at least a portion of the video transmission on a site on a network.

2. The method of claim 1 wherein in step i) the GPS coordinates of the site at which the event occurs are obtained and transmitted to a central site maintained by the organization.

3. The method of claim 2 wherein the GPS coordinates are provided to the central site by a member of the organization.

4. The method of claim 1 wherein in step iii) the video transmission is provided to a central site maintained by the organization.

5. The method of claim 1 wherein in step iii) a plurality of video transmissions are received.

6. The method of claim 5 wherein in step iv) portions of a plurality of video transmissions are posted on the site.

7. The method of claim 1 wherein in step iv) the portion of the video transmission is posted together with attribution of copyright to the member providing the video transmission to the central site.

8. The method of claim 1 wherein in step iv) a premium is provided to the member providing the video transmission to the central site.

9. A method of providing video information pertaining to an event to a site on a network maintained by an organization, the method comprising the step of transmitting information identifying the location of an event to a central site maintained by an organization, whereby upon receipt of the information the central site transmits the information to members of an organization and prompts at least a portion of the members to attend the event and provide to the central site video transmissions of the event from cellular telephones operated by such members, wherein the central site subsequently posts at least a portion of the video transmissions on a site on a network maintained by the organization.

10. The method of claim 9 wherein the GPS coordinates of the site at which the event occurs are transmitted to the central site maintained by the organization.

11. The method of claim 9 wherein the portion of the video transmissions are posted together with attribution of copyright to the members providing the video transmissions to the central site.

12. The method of claim 9 wherein a premium is provided to the members providing the video transmissions to the central site.
